(19) United States
(12) Patent Application Publication
(10) Pub. No.: US 2026/0249222 A1
(43) Pub. Date: Aug. 27, 2026

(54) AIR FILTER WITH COUPLED SAMPLE COLLECTION/ANALYSIS

(71) Applicant: KAPPA FILTER SYSTEMS GMBH, Steyr-Gleink (AT)

(72) Inventors: Klaus KRÜGER, Steyr/St. Ulrich (AT); Urs HUNZIKER, Meilen (CH)

(73) Assignee: KAPPA FILTER SYSTEMS GMBH, Steyr-Gleink (AT)

(21) Appl. No.: 18/877,443

(22) PCT Filed: Jun. 28, 2023
(86) PCT No.: PCT/EP2023/067733

§ 371 Date: Dec. 20, 2024

(30) Foreign Application Priority Data
Jul. 1, 2022 (DE) 10 2022 116 538.8

(51) Int. Cl. B01D 46/00; B01D 46/42; G01N 1/22

(52) U.S. Cl. CPC B01D 46/0086; B01D 46/429; G01N 1/2205; G01N 1/2273

(57) ABSTRACT

The present disclosure relates to a filter module for filtering air from at least a part of a building or of air from an exhaust air purification unit of a production process, wherein the filter module can be replaceably arranged in a filter system and the filter module comprises a filter body which is configured to filter air when it flows through it. The filter body comprises a filter region, which filters the air which is flowing through from air accompanying substances, and an analysis region, which is configured to support the analysis of at least one of the air accompanying substances and the air quality.

### TECHNICAL FIELD

The present invention relates to a filter module and a method for filtering air of at least a part of a building or of air of an exhaust air purification unit of a production process. Furthermore, the invention relates to a filter system with the filter module.

### BACKGROUND OF THE INVENTION

Filter systems in room air systems are used for the ventilation and venting of rooms in buildings and filter pollutants from the air. The filters also serve as sample collectors and the collected pollutants can also be analyzed later after the use time of the filter has expired.

If a normal air filter is used as a sample collector and is analyzed after the service life, it can often not be assumed that a part of the filter is representative of the total load of the filter because of the air flow asymmetries. This means that the content of the filter as a whole has to be analyzed, which is associated with a high material and analysis effort. It would therefore be useful if only a section of the flow region would be representative of the load of the total filter and could be analyzed.

### SUMMARY OF THE INVENTION

It is an object of the present invention to provide a filter which enables a more exact analysis of the air to be filtered.

This object is solved with a filter module and a method for filtering air of at least a part of a building or of air of an exhaust air purification unit of a production process according to the subject matter of the independent patent claims.

According to a first aspect, a filter module for filtering air of at least a part of a building or of air of an exhaust air purification unit of a production process is described. The filter module is replaceably arrangeable in a filter system and the filter module comprises a filter body, which is configured to filter air when it flows through it. The filter body comprises a filter region, which filters the air which is flowing through from air accompanying substances, and an analysis region, which is configured to support the analysis of the air accompanying substances and/or the air quality.

The filter body is configured in such a way that, at a speed of the volume flow of 0.1 m/s to 5.0 m/s through the filter body, the pressure drop of the air which flows through the filter body is less than 450 Pascal. The filter region is configured in such a way that, at a pressure drop range of 10 Pa to 450 Pa across the filter module, the composition of the air flow in the analysis region changes by less than 40% compared to the composition in the filter region, and wherein the analysis region is configured relative to the filter region in such a way that the air in the analysis region comes into contact with the same air accompanying substances or air particles as in the filter region by more than 90%.

According to a further aspect, a filter system is described, which comprises a control unit and at least one filter module described above,
wherein the at least one filter module is suitable for exchanging analysis data, which are necessary for supporting the analysis of the air accompanying substances and/or the air quality.

According to a further aspect, a method for filtering air of at least a part of a building or of air of an exhaust air purification unit of a production process with an exchangeable filter module described above is described.

A filter system according to the invention is typically used in buildings for filtering and purifying air or also for purifying air in production processes of factories. For this purpose, a filter system comprises, for example, active flow generators, such as, for example, fans, or is integrated into a ventilation system of a building, which comprises, for example, a central active flow generator.

The filter system comprises, for example, a housing, in which a filter module is arranged or a plurality of filter modules are arranged in series along the flow direction of the air through the filter system or parallel to the flow direction. A filter module according to the invention is arranged exchangeably in the filter system. For example, corresponding guide rails can be provided, along which the filter module can be pushed into the operating position within the filter system. Furthermore, for example, releasable fastening means, such as, for example, screws or clamping closures, can be provided in order to arrange the filter module modularly and exchangeably in the filter system.

The filter module comprises, for example, a flat (German: flächig) filter material, which is fixed in a circumferential support frame. The filter module can be configured as a pocket filter, wherein a plurality of pockets of filter material are fastened in the support frame and the air flow is introduced into the pockets in order to filter the inflowing air. Furthermore, the filter module can also be configured as a cartridge filter, hose filter, candle filter, compact filter and HEPA filter.

The filter module according to the invention and in particular the filter material is configured in such a way that, at a speed of the volume flow of 0.1 m/s to 5.0 m/s through the filter body, the pressure drop of the air which flows through the filter body is less than 450 Pascal. Accordingly, the filter module serves for purifying large air masses with a low pressure loss. These values can be adjusted structurally in particular by the selection of the filter material and the corresponding pore sizes and fabric structures of the filter material.

The filter module comprises in particular the filter region which assumes the function of filtering the air. Furthermore, the filter module according to the invention comprises the analysis region, which is configured to support an analysis of the air. The support of an analysis of the air can consist, for example, in air being branched off in the analysis region and being discharged to an air analysis device, for example in the filter system. Furthermore, as described below, the analysis region can comprise active analysis elements, such as, for example, sensors or sample chambers for collecting air samples or accompanying substances.

According to the invention, the analysis region is arranged relative to the filter region in such a way that, at a pressure drop range of 10 Pa to 450 Pa, in particular up to 250 Pa or up to 150 Pa, across the filter module, the composition of the air flow in the analysis region changes by less than 40% compared to the composition in the filter region, and wherein the analysis region is configured relative to the filter region in such a way that the air in the analysis region comes into contact with the same air accompanying substances or air particles as in the filter region by more than 90%. The filter performance of the filter module according to the invention, in particular of the filter region, is measured, for example, according to EN ISO 16890, and is better than 50% for one of the classes “ISO Coarse”, “ISO ePM10”, “ISO ePM2,5” or “ISO ePM1”.

If the filter module is operated within these characteristic values, the filter region can come into contact with the same air accompanying substances and/or air quantities as the filter region by more than 90% due to the arrangement of the filter region proposed in the invention. The composition of the air flow also changes by less than 40%, in particular less than 25%, in particular less than 10%, further in particular less than 4%, at a pressure drop variation of 50 Pa to 450 Pa across the filter system in the analysis region compared to the filter region.

This configuration is achieved in particular if the analysis region is arranged and configured at a suitable position in a suitable size in the filter region or the filter module. For example, the analysis region is at a sufficient distance from the support frame of the filter module or from the edge of a flow channel, in which the filter module is arranged in the filter system, in order thus to avoid edge flow properties, which bring about a different composition of the air accompanying substances or air particles of the air or a different pressure drop range of the air, relative to a, for example, central filter region. Accordingly, the analysis region is arranged, for example, at a distance of more than 0.5 cm, more than 2 cm, in particular of more than 8 cm from an edge region of the filter module.

The solution according to the invention is suitable for filter modules, for example in the manner of a pocket filter, or secondary filter systems. With a secondary filter system, an air circulation system with filtering for installation in the room is generally described. The secondary filter system may be mobile or stationary. In contrast thereto, for example, controlled housing ventilations, permanently installed and piped ventilation systems are referred to as primary filter system. In the secondary filter systems, zones with laminar air flow can be created, in which a corresponding filter module according to the invention is arranged. For example, a support frame of the filter material of the filter module forms a suitable mechanical strength platform, so that the additional elements of the analysis region, for example sensors or air guiding elements, can be fastened in a sufficiently vibration-free manner (so that no element flutters in the air flow) directly or indirectly. This reduction of vibrations is primarily also of significance when sensors are used in the analysis region, which are vibration-sensitive (for example MEMS or other electromechanical components).

Due to the arrangement of the analysis region, the filter module according to the invention provides in particular an integrated support for the online or offline analysis of the pollutant load of the air which is flowing through. In particular due to the arrangement of the analysis region, the analysis region can, for example, take measured values or samples of the air, which are representative of the air flow, in particular in a temporal or quantitative informative capacity.

According to a further exemplary embodiment, the analysis region has a collection volume for air accompanying substances. The analysis region can, for example, form a pocket or bag, in which the collection volume is formed. Accordingly, air particles or other air accompanying substances can collect therein, which can be analyzed later, for example when the filter module is removed. Furthermore, according to an exemplary embodiment, a sensor can be installed in the collection volume in order to analyze the collected air accompanying substances. For a pure sample collection of air accompanying substances, solid air particles and/or liquid foreign substances, which precipitate in the sample collector, come into consideration.

According to an exemplary embodiment, the filter module has a sampling device which is arranged in the analysis region, in particular exchangeably and/or removably, and in which the collection volume is formed. The sampling device is in particular sealable in order to seal the collection volume partially, completely and/or selectively. The sampling device can for example be sealed after a certain period of time, in which air accompanying substances are collected in the collection volume. Subsequently, the sampling device can be removed and the collected air particles or liquid can be analyzed in an external laboratory. Due to the sealing, for example, a non-destructive opening of the sampling device is not possible. The sampling device may for example be a closable bag of filter material and may comprise a closure mechanism, such as for example a closable flap. The corresponding opening and closing of the sampling device can for example be controlled by a control unit of the filter system. Alternatively, the sampling device can be sealed by the technician during the filter change. Therefore, in the analysis region, one or more predefined collection zones (i.e. collection volumes) can be provided, which for simple sampling for the laboratory are removed with little effort and are protected from later contamination (both contamination to the inside, i.e. by the operator, and also to the outside, i.e. contamination of the surroundings by collected substances with the filter system). A possible realization of this functionality may be a punching forceps (at best integrated into the filter system) with a closure cap, which is analyzed after removal in a laboratory.

According to a further exemplary embodiment, the analysis region has an adhering region for adhering and accumulating air accompanying substances. The adhesion can for example be formed by a defined formation of the pore size of a filter material in the analysis region, or can be formed by certain adhesive-like substances, to which in particular the air particles adhere in the air. Normally, only a small proportion of foreign substances is present in the air flow, therefore the possibility of the adhesions in the analysis region serves for concentrating the substances in order to enable a later simplified detection (in situ or later offline). From the period of time of the concentration, the actual concentration content of the air guiding substances can be concluded later.

According to a further exemplary embodiment, the analysis region has a reactive region for reacting and converting air accompanying substances and/or air components. The reactive region has in particular corresponding substances, which react with certain air accompanying substances or air components in order to bind them in the analysis region and/or in order to convert them into a measurable and analyzable substance. Since certain air accompanying substances are not trivially collectable (e.g. gases, e.g. O₂ or CO2 content of the air) or unstable and since they can for example oxidize or reduce, a corresponding conversion is advantageous. A built-in chemical (react and thus stabilize) or physical (seal, separate) function in the reactive region preserves (in particular by concentration of an air accompanying substance, until the respective reaction is detectable) the respective substance for a local indication (e.g. color change or by means of fluorescence) or for a later analysis (for example in the laboratory). In the analysis region, for example, containers are provided, in which the reactive region is formed. An example of this are so-called test tubes, e.g. Drager tubes. A test tube consists, for example, of a thin glass tube, which is closed at the ends by melting. In the interior, substances are applied to inert carrier materials, which after a chemical reaction with the respective air accompanying substances to be detected have an indicator function by, for example, visual reactions such as color changes.

According to a further exemplary embodiment, the analysis region has an air guiding region for extracting the air flow (German: Luftstromauskopplung) from the filter body. For example, the analysis region can comprise a conical air guiding region, in which an air portion is taken up from the flowing air and is transported further to a desired location in a further line system outside the filter module. For example, the air portion can be collected in a collection container of the filter system and can be provided for the further analysis. By means of the air guiding region, therefore, for example, a representative portion of the air flow can be deflected such that it can be further processed in a separate analysis unit. The main task here is to maintain this representative portion retention even in the case of pressure fluctuations, in particular in the case of transitions from laminar to turbulent flow.

According to a further exemplary embodiment, the analysis region has a sensor element for measuring at least one parameter of the air accompanying substances and/or the air quality. The direct measurement of foreign substances or groups of foreign substances in the air flow can be provided by means of a sensor element integrated in the analysis region. This can for example relate to the amount of fine dust of a certain diameter class. Furthermore, for example, other foreign substances can be filtered away beforehand, so that only the certain air accompanying substances strike the sensor. In the case of turbulences due to turbulent flows of the air through the filter module, heavier substances (particles, molecules, aerosols, etc.) are moved away by centrifugal forces in the radial direction of a flow roller, which leads to dehomogenization of the air flow composition. By means of the air module according to the invention, by ensuring the flow flow according to the invention, despite possible pressure differences, a representative air flow composition can be measured by the sensor.

According to a further exemplary embodiment, the sensor element comprises a MEMS sensor. Furthermore, the sensor element can be configured in particular such that the sensor element can be used for a Fourier transform infrared spectrometer analysis FTIR and/or a near infrared spectroscopy analysis. In this case, parameters such as particles per volume can be measured. In this case, it can be relevant in particular that air pressure changes in the analysis region and in particular air pressure differences between the analysis region and the filter region are kept as small as possible or are prevented. By means of the filter module according to the invention, the air pressure difference between the analysis region and the filter region is reduced, so that more exact measurements by means of the sensor are possible.

According to an exemplary embodiment, the sensor element comprises a resistance sensor for measuring the air accompanying substances and/or the air quality. In this case, for example, a trigger substance can additionally be used in order to measure the presence of certain foreign substances in the air (e.g. measurement according to Bresle). It is important in particular that the air flow through the analysis region is representative of the air flow and the air quality in the filter system and accordingly of the air flow through the filter region.

The sensor element can comprise, for example, a microphone and detect the noise level in the room and in particular the location of a noise source. By measuring and evaluating the noise level in a room, the number and intensity of speech-active persons in the room can be concluded and the ventilation power of the fan unit can be adapted thereto via the control unit, since the emission of aerosols by persons increases with the speech volume. In other words, the regulation of the ventilation power can thus be adjusted via the noise level in the room. The more persons speak, or speak loudly, the more aerosols are emitted and the higher the ventilation power can be, since then, for example, the additional sound of the devices, such as e.g. the fan unit, is not perceived and does not disturb. If one or more persons sit still in the room, the ventilation power goes down, because it must be quiet for concentrated work, wherein however also hardly any aerosols are emitted.

According to an exemplary embodiment, the filter module comprises a communication unit for communicating data relating to the air accompanying substances and/or the air quality to a control unit of the filter system, in particular for controlling the filter module. The communication unit is configured to transmit information about the air accompanying substances and/or the air quality to the control unit or also control signals, which can be created based on measured parameters, in order to generate, for example, control signals relating to indication signals (alarm signals) or air flow control signals.

According to a further exemplary embodiment, the filter body comprises a plurality of analysis regions. For example, two, three or more analysis regions can be integrated in the filter module. This enables a higher functionality and a more exact analysis of the air content and the air accompanying substances over a larger area of the filter module.

According to a further exemplary embodiment, the analysis region is configured to indicate the presence of substance classes, wherein the analysis region is configured to filter and collect air particles from the air. Substance class is understood in chemistry to mean all substances which can be combined by a common property. Each substance can belong to a plurality of groups, depending on which property is used for classification. Additionally or alternatively, the analysis region can be configured to preserve samples of the air particles, wherein in particular sorbitol and/or activated carbon is provided in the analysis region for preservation. In a further especially exemplary embodiment, a filter module contains on the one hand a broadband-reacting trigger system, which responds to certain substance classes and visualizes their presence. On the other hand, the analysis region can contain a sample collection (which at most can also concentrate substances and/or react, initialize or preserve them for a longer period of time; this can be realized, for example, with activated carbon or sorbitol). Thus, it becomes possible in response to a response of the visual contamination indication at a later point in time then to analyze the substances collected in the sample collector in detail. Specific mechanisms for the detection of entire substance classes can provide, for example, a layer detection of dusts and heavy metals, e.g. iron, mercury, copper, which can be detected in color by classical inorganic color complexes. Thus, iron and Cu are colored blue or orange as chromaoferrate layers. Furthermore, a layer detection of oxidizing gases, e.g. NoX and ozone, can be conducted. A color reaction from colorless to blue by means of potassium iodide-iodine starch can be generated in this case.

In particular, a virus load of the air to be filtered can be detected in the analysis region, in particular by the described trigger system. For example, a concentration of viruses, such as e.g. Sars-CoV 2 viruses, can be determined. In this case, a biosensor is arranged as a sensor element in the analysis region. The air to be filtered flows over the biosensor. The biomarker can for example comprise biomarkers, which react with the viruses and bring about corresponding measurable (e.g. optical) reactions.

The biosensor can function on the basis of the PCR test methodology (real-time quantitative reverse transcriptase polymerase chain reaction), according to which gene sequences of a virus, e.g. Sars-CoV 2 virus, are detected. Furthermore, the biosensor can function in the manner of an antigen test and can implement fluorescence- or chemiluminescence-based test methods, in which for example the virus protein is detected on the basis of a certain staining.

In one embodiment of the biosensor, the latter can be configured as a waveguide interferometer. Such a photonic biosensor recognizes various light-based phenomena of the viruses for the rapid detection and the quantification of viruses or corresponding biomarkers. Among the various photonic biosensors, silicon-photonic biosensors, which are based on the principle of evanescent waves, can be used.

Furthermore, the biosensor can be configured as a nano-photonic biosensor on the basis of interferometric bimodal waveguides (BiMWs). In order to capture and detect viruses from a sample, the surface of the BiMW sensor is modified with specific receptors, which target external antigens of the virus, such as for example the spike (S) protein of SARS-CoV-2. As soon as the air to be filtered flows over the biosensor, the virus particles are captured by the receptors on the sensor surface and generate an interferometric signal, which can be recorded in real time. The reaction of the sensor is for example directly proportional to the virus concentration in the air to be filtered and thus enables an exact quantification of the virus load in the air. Furthermore, a layer of phenols can be provided, such as for example bisphenols, nonylphenols, chlorophenols, wherein a color reaction of red (iron complex) or with dimethylaminobenzaldehyde, i.e. violet red, is generated. Furthermore, a layer can be provided, which contains potassium permanganate (reacts for example on SO2 [sulfur dioxide], odor-intensive sulfur compounds=H2S, formaldyde, or for example permetrine).

According to a further exemplary embodiment, the filter module comprises an energy generating unit, which is configured to obtain energy by means of the air flow through the filter module and/or by electromagnetic waves, which energy is used in particular for operating the analysis region. For example, energy can be obtained via the pressure difference over the filter module for example by means of a propeller, galloping harvester, piezoelectric flags (piezo element) and/or by receiving and rectifying a high-frequency vibration (for example from a WLAN router). This energy is used for the operation of the units in the analysis region or for systems in the filter system. For example, therefore, no electrical connections are necessary between filter system, filter module and/or surrounding ventilation system.

According to a further exemplary embodiment, the analysis region comprises a plurality of sample chambers, through which the air for filtering air particles can flow selectively, in order to enable in particular a time-delayed sample collection. The sample chambers can be arranged distributed or together in a certain region of the filter body or within the filter region. The sample chambers are arranged in such a way that the speed according to the invention of the volume flow of 0.1 m/s to 5.0 m/s and the pressure drop of the air which flows through the filter body is less than 450 Pascal. Furthermore, the sample chambers are configured and arranged in such a way that, at a pressure drop range of 10 Pa to 450 Pa across the filter module, the composition of the air flow in the sample chambers of the analysis region changes by less than 40% compared to the composition in the filter region, and the sample chambers in the analysis region are configured relative to the filter region in such a way that the air in the sample chambers comes into contact with the same air particles as in the filter region by more than 90%.

The sample chambers can be selectively flowed through in that, for example, one or selected sample chambers are accessible for the air flow as a function of time. The sample chambers may comprise an opening mechanism, such as for example a controllable actuating element, which selectively opens the sample chambers. For example, an air guiding system, consisting of air guides and control valves, can be used in order to guide an air flow to a certain sample chamber in a targeted manner at a certain point in time.

According to a further exemplary embodiment, the filter body, in particular in the filter region, comprises a fleece as filter material, wherein the fleece comprises in particular an entire layer or a plurality of layers. The filter body is arranged in the filter module, in particular exchangeably, wherein the fleece is configured in particular as a disposable filter. A fleece consists of fibers of limited length, continuous fibers (filaments) or cut yarns, which are joined together and connected to form a fleece (a fiber layer, a fiber web). As a result of the interlinking of the fibers, an air-permeable material with narrow, small-pore air passages is provided, as a result of which a good filter effect, in particular of air particles, is achieved.

Since an exchangeable filter module (in particular as a disposable filter) does not have to be adapted exactly to the surrounded housing of the filter system, it is furthermore advantageous if the filter module prevents possible air resonances. In the case of filter materials composed of regularly arranged filter medium (for example woven, punched, etched or drilled filters), there is the possibility that resonances and therefore negative effects arise as a result of self-organizing effects of the air flow (noises, detachment of already embedded pollutants again, in particular during start-up and stop of the installation, in the case of variance of physical measured values, etc.). It has been found that, in the solution according to the invention, the use of a layer of a fleece damps this vibration effect. This damping arises as a result of the fact that fibers are deposited and brought into adhesion irregularly and randomly. This irregularity reduces the vibration-related self-organization potential. This damping can be intensified when using a plurality of fleece layers in the construction of the filter material, in particular if these comprise at least slightly different fleece materials or fleece layers. A difference can be generated by the production of fleece materials.

According to a further exemplary embodiment, the filter region and the analysis region are arrangeable in parallel in the air flow in such a way that the filter module is configurable as part of a secondary filter system and/or the filter module is configurable as part of a pocket filter.

According to a further exemplary embodiment, the inflow of the air to the analysis region is controllable in such a way that a flow and/or pressure difference of the air in the filter region and in the analysis region is adjustable, in particular that the pressure difference is controllable or regulatable. For example, a flow and/or pressure difference between the filter region and the analysis region can arise as a result of flow disturbances of the air flow or, for example, when the filter region is occupied. This can lead to measurements in the analysis region, which are no longer representative of the entire air flow. Accordingly, for example, a flow property can be adjusted individually between the analysis region and the filter region in a targeted manner via an air guiding system or via a flow generator, in order to adjust flow properties at the two regions in a targeted manner.

According to a further exemplary embodiment, the analysis region can be flowed through continuously or discontinuously. Therefore, for example, in the case of a discontinuous inflow of the analysis region, the latter can be selectively covered and the air flow can be flowed against only at one measurement time. Alternatively, for example, in order to achieve long-term measurements, the analysis region can be flowed against permanently and continuously.

According to a further exemplary embodiment, in a discontinuous operation the analysis region can be activated relative to the filter region in a time duty cycle ratio of less than 10:1, in particular of less than 100:1, and/or the active measuring time of a flow-through cycle of the filter body is shorter than 10 ms, in particular shorter than 50 microseconds, in particular preferably shorter than 1 microsecond, wherein the flow-through cycle is in particular adjustable. A duty cycle of 10:1 means, for example, that of 10 time units in which the filter region is flowed through, 1 time unit is flowed through the analysis region. Therefore, a discontinuous measurement is enabled, in order to save in particular energy for the measuring system. For example, it may be sufficient that the measurement in the analysis region can only take place during a very short time with a long rest phase. Specifically foreign substance loads in an air flow usually occur over a longer period of time. Thus, temporal intermediate values can also be interpolated from individual measured values, without a continuous measurement having to take place. Thus, it was possible to achieve good measurement results with a duty cycle of less than 1:10, in particular in a duty cycle of less than 1:100. In this case, if the duration of the measurement is minimal, it is particularly helpful, for example, to determine the measurement of a color change of an indicator in the analysis region with a measuring time of less than 10 ms, in particular less than 50 microseconds, or less than 1 microsecond.

According to a further exemplary embodiment, the filter module comprises a coupling element, which is mechanically and/or electrically coupled to the analysis region and can be coupled to a connection of a filter system. The coupling element is configured in particular such that a releasable coupling between the analysis region and the connection of the filter system can be provided. Furthermore, the coupling element is configured in particular such that, when the filter module is introduced into an operating position in the filter system, a coupling between the connection of the filter system and the analysis region can be generated automatically. The coupling element is provided in particular on an exhaust air side of the filter body. The coupling element serves for example for the flow coupling of air flow, which is captured in the analysis region and is intended to be forwarded to an external analysis region, for example in the filter system or in an external laboratory. Additionally or alternatively, the coupling element serves for signaling or electrical coupling between the analysis region and devices of the filter system. The coupling element is provided in particular on the filter module, for example on the support frame of the filter module, such that, in an operating position of the filter module in the filter system, a coupling to a correspondingly corresponding coupling element of the filter system is enabled. The coupling element can be for example an electrical plug. Furthermore, the coupling element can be an air connection or flange-like structure, which can be coupled in a sealing manner to a corresponding air connection of the filter system when the filter module is arranged in the operating position in the filter system.

For the case that a measuring unit or sensor for the air data is used in the analysis region, the filter module can carry out the decoupling of the measured air from the air flow and then feed this air flow to the air sensor system in the field of the system. This has the advantage that the air sensor system does not have to be replaced with every filter module change. In this case, the filter module can be configured such that the connections to the air sensor system are automatically coupled and decoupled by means of the coupling element during a filter change. In the case of a pocket filter as a filter module, this can be realized, for example, in that, with the insertion of the support frame, the measuring air line with corresponding coupling elements is also inserted. By placing this plug-in connection in particular in the exhaust air region of the filter system, a pollution of the plug-in connection can be reduced or prevented.

According to a further exemplary embodiment, the filter module comprises a further filter body, which consists in particular in each case of a pocket filter or a hose filter, wherein at least one filter body consists exclusively of an analysis region, which is configured for the analysis of the air accompanying substances and the air quality. For example, at least one filter body consists exclusively of an analysis region comprising a power supply unit, which is configured in particular such that a power supply can be provided for a predetermined service life of the filter module. For example, the filter module accordingly comprises filter modules arranged parallel next to one another or one behind the other, in particular comprising a plurality of pocket or hose filters. Instead of a further filter body as a pocket or hose filter, the further filter body can consist exclusively of an analysis region. Since the further filter body thus does not have to provide any regions for a filter region, a very large analysis region or a plurality of different analysis regions can be formed in the further filter body. Furthermore, in the analysis region of the further filter body, an energy supply device or electrical supply unit, such as for example a battery with a high capacity, can be arranged, which for example can supply the filter module with energy over the service life thereof. A life-long battery enables a simple retrofitting of existing filter systems by the solution according to the invention, without additional electrical and/or installation measures.

According to a further exemplary embodiment, the filter body, in particular in the filter region, comprises at least two fleece layers and a filter membrane arranged between the fleece layers, which are arranged in a layered manner one above the other in a layer composite, wherein in particular the middle filter membrane of the layer composite comprises a larger surface area than the two outer fleece layers.

In particular according to an exemplary embodiment, a first direction (e.g. X direction) and a second direction (e.g. Y direction) are defined, which span a plane, wherein the middle filter membrane is corrugated with corrugation sections such that the corrugation sections are arranged one behind the other along a first direction. The corrugation sections run irregularly and asymmetrically to each other, in particular within the plane. The filter body is arranged such that air can flow over the filter body along the first direction or along the second direction. For example, the x direction is the air inflow direction of the air and the corrugation sections run transversely to the first direction along the second direction. The asymmetry of the corrugation arrangement and shape can be used for vibration damping. Alternatively, the filter body can also be flowed against in the Y direction and therefore parallel to the extent of the corrugations. The corrugation sections therefore form, for example, a shark skin-like riblet structure, which brings about a reduction of the flow resistance. Depending on the entry conditions (inflow cross section, volume flow, depth of the filter material which is to be flowed through) into the filter body, one or other configuration can be particularly advantageous. The asymmetry of the corrugation arrangement can be achieved by a self-organizing compaction process, in which the feed rate of the filter membrane is significantly higher than the feed rate of the two cover fleeces. The asymmetry of the corrugation arrangement arises as a result of thermal fixing of the three layers at a predetermined point in time. In addition to the advantages already described, this asymmetry acts in a stabilizing manner on deflections in the x-y plane.

According to a further exemplary embodiment, the filter body has a thickness of 2 mm to 10 mm, in particular of 3 mm to 7 mm, in the filter region. Additionally or alternatively, the number of corrugation sections is between 0.5 and 3 corrugations per cm. This enables a filter performance similar to a HEPA filter, but with a pressure drop in the region of a normal F7 filter (i.e. within the operating parameters of the solution according to the invention).

According to a further exemplary embodiment, the filter region is configured from a hydrophobic filter material. Furthermore, the filter region can be configured from natural fibers. The filter region can further contain a polyolefin, in particular a polypropylene. In a further example, the filter region contains cellulose, cotton and/or hemp.

If the air flow to be filtered is loaded with a high aerosol load, known filters can have a tendency to soaking. On the one hand, this can statically increase the pressure drop across the filter, but also dynamically overcharge a subsequent volume flow regulation by means of VAV in the sense of its regulation speed due to the very rapidly changing pressure conditions. The solution according to the invention can solve this problem by a suitable choice of material of the filter material: either a hydrophobic material (e.g. a polyolefin, in particular polypropylene, which is substantially free of polar groups) or an absorbent material with a special (for example deep) tendency to swell (e.g. a natural fiber, in particular a cellulose fiber, cotton or hemp) is used. Thus, the tendency of filling filter openings with micro- or nanoscale water droplets is reduced. It has been found that the fungicidal, virucidal and bactericidal properties of hemp are favorable and make it an ideal filter constituent.

According to a further exemplary embodiment, the analysis region comprises an air guiding unit, which is configured in particular to form an air path to the supply air side and/or to the exhaust air side of the filter body, wherein the air guiding unit is configured in particular exchangeably in the filter body. The air path thus leads through the analysis region and optionally in regions through the filter region. The air paths lead the air for example to a measuring device of the filter system, wherein the filter module can be replaced independently of the measuring device. In particular, an intermediate material with filter properties or with active reagents can be provided in the air path. With a filter module change, in each case unloaded intermediate material or new active reagents (which can interact with constituents of the air flow) can be supplied.

According to a further exemplary embodiment, the filter module comprises a weighing unit, which is configured to weigh the filter occupancy, in particular such that a measured value falsification by the pressure of the air flowing through the system can be compensated. With corresponding additional mechanisms, a compensation of the measured value falsification by the pressure of the air resistance can be achieved during the operation of the filter system. This also enables the determination of a high filter occupancy for an operating mode of the filter system at a low volume flow, which does not lead to the triggering of the differential pressure monitoring of the filter in the case of customary filter monitoring. In particular, the weighing unit can comprise a ground contact in the installed state of the filter module in the housing of the filter system and thus introduce the weight force of the filter module into the ground. As a result, a weight measurement of the filter module can be carried out.

According to a further exemplary embodiment, the filter module comprises a receiving device, which is configured to receive a unique ID, wherein the unique ID comprises information regarding the location of use of the filter module. The receiving device can be configured to read the unique ID from a QR code, a barcode, an OCR font or an RFID tag. Furthermore, the receiving device can be configured to receive the unique ID via NFC, Bluetooth, WLAN, proprietary protocols or protocols of building control systems, in particular LON or EIB. The operation and/or the configuration of the filter module is adjustable based on the unique ID.

In a further particularly preferred embodiment, the unique ID comprises information regarding the installation location of the filter module in the filter system. This ID enables the operating parameters required for the specific operation to be preselected or stored data of a system configuration to be retrieved from a preconfigured operating mode of the filter system or of the filter module. In particular when using encrypted protocols, a new configuration can thus be avoided during the filter change and a ‘plug and play’ can be realized. Corresponding data can be transmitted from the filter system or the filter module during the change or can be transferred via cloud. The transmission of the unique ID to the filter system can take place using mechanisms using QR code, barcode, OCR fonts (and their successors for machine-readable fonts), RFID, NFC, Bluetooth, WLAN, proprietary protocols or protocols of building control systems (LON, EIB, etc.). This mechanism also makes it possible to deliver a filter system in which functions are only enabled if a part of the unique ID belongs to the agreed delivery scope.

According to a further exemplary embodiment, the filter module comprises a transmitting device for transmitting filter body-related data, wherein the transmitting device is configured to transmit the data by means of RFID, NFC, Bluetooth, WLAN or protocols of building control technology. A warning signal can be generated on the basis of these data by means of a control unit and/or a measure can be taken which in particular relates to a throughput through the filter module.

The transmitting device can for example represent an antenna or a conductor-based system which signals the readiness of the ventilation system to receive data from the filter. Such data can relate not only to parameters relating to the air accompanying substances of the air, but also contain information and details of the filter module. Thus, for example, depending on the performance of a filter module used, the air volume can be adapted by the filter module or the filter system. Furthermore, when a run time or occupation density of the filter module is exceeded, a signal can be emitted which can either be interpreted as a maintenance signal or can also be used as a control signal in order to reduce the air throughput quantity. An embodiment variant of the transmitting device can be an RFID transponder (which for example also comprises filter data in encrypted form). Furthermore, other communication mechanisms such as NFC, Bluetooth, WLAN, etc. can also be used. For wired communication, in addition to proprietary protocols, bus systems of building control systems (LON, EIB, etc.) are also available. With this mechanism, in particular, durability of reagents in the sample collection according to the invention or in the sample chambers can be pointed out and reacted accordingly.

According to a further exemplary embodiment, the analysis region comprises a plurality of through-flowable regions, which can be selectively controlled in such a way that the through-flowable regions can be flowed through independently of one another at a predetermined point in time and for a predetermined through-flow duration in such a way that a binary tree can be formed on the basis of the measurement at the predetermined points in time of the through-flow of the individual through-flowable regions. The data of the measured parameters of the air accompanying substances in the through-flowable regions are indicative of a state of the air flow over a time range and of a change of state over the through-flow duration of the through-flowed regions. Due to the additional temporal dimension, the various states and changes of state over certain time ranges of the air accompanying substances can thus be mapped in a data matrix or in a binary tree.

Specifically if filter modules remain in an installation for a longer period of time, it is of interest to be able to determine when a certain foreign substance load has occurred. This can be realized, for example, with the exemplary embodiment of the filter module with selectively through-flowable regions, which releases chambers at time intervals and seals others again. As a particular variant thereof, a binary releasing (1) or closing (0) of chambers can also be realized. Thus, for example, the quantitative analysis and the recombination thereof of the respective binary trees to individual points in time of the through-flowed regions can result in an even finer resolution of the foreign substance load or of the air accompanying substances of the air. In particular, the energy for the selective closing and opening of the through-flowable regions can be obtained from the air flow.

According to a further exemplary embodiment, the analysis region is arranged more than 0.5 cm, in particular more than 1 cm, further in particular more than 2 cm or more than 8 cm, from the edge or support frame of the filter body, which acts as an outer air flow limitation, so that no edge effects with air flow turbulences occur in the analysis region.

According to a further exemplary embodiment, the filter body, in particular in the filter region, comprises a plurality of filter layers, which are arranged one behind the other in the flow direction of the air through the filter, wherein in particular the first filter layer facing the supply air side filters more coarsely than at least one of the second filter layers following the following first filter layer in the flow direction. Thus, initially coarser particles can be filtered, while smaller particles flow through the first layers and are only filtered out later in the case of the fine layers. Thus, a uniform occupancy takes place in the filter body along the air flow direction.

According to a further exemplary embodiment of the filter system, the control unit comprises a visualization unit, which is configured to visualize the air quality and the analysis of the air particles, in particular in a location-dependent manner at the location of the respective filter system. Furthermore, the control unit is configured in particular such that it generates an action recommendation based on the air quality and the analysis of the air accompanying substances.

In a particularly preferred embodiment, a plurality of filter modules are operated with one another in such a way that they clean the air from an individual building section. These filter modules have a corresponding additional equipment, which can exchange data regarding air details and thus air measurement data can be visualized at at least one point or actions dependent thereon can be initiated. Here, both filters of a primary ventilation among themselves and also filter systems of secondary ventilations among themselves, and also all of them, can form a network with one another and interact with one another. In particular, a location-dependent air quality can thus be visualized, an action recommendation can be given or a measure can be initiated (e.g. “meeting room 2 has bad air” or “air quality low, please raise the fan”).

According to a further exemplary embodiment, the filter system comprises a flow control, for example comprising a fan or other flow generators. A flow velocity of the air through the filter body and an air pressure of the air at the supply air side of the filter body are adjustable by means of the flow control. The flow control is configured to adjust a pressure drop difference from a pressure drop between the supply air side and the exhaust air side in the filter region and the analysis region in each case individually, in particular by means of mechanical and/or mechatronic flow control systems, such that a constant volume flow through the filter region and through the analysis region is adjustable, in particular based on a subsequent adaptation based on measurement data.

The flow control systems comprise, for example, a mechanical cross-sectional change of the inlet in the analysis region, wherein the pressure drops in the filter region and in the analysis region are taken into account such that the air flow portion in the analysis region remains similar to and representative of the air flow portion in the filter region. A pressure drop in the analysis region can be adaptively adapted, depending on the pressure drop in the filter region.

The control unit can for example take into account that a pressure drop in the analysis region is for example taken into account in the measurement data. Furthermore, the analysis can function over a wide pressure drop range in that, for example, in the post-processing of the measurement data by the control unit, the pressure difference is taken into account (e.g. by permanently recording the pressure difference and taking these data into account in the evaluation).

According to a further exemplary embodiment of the filter system, the flow control can adjust the speed of the volume flow in the range 0.1 to 5.0 m/s, in particular 0.3 m/s to 2.8 m/s and/or the pressure drop across the filter body in at least one operating mode below 250 Pa, in particular below 150 Pa, in particular below 60 Pa.

According to a further exemplary embodiment, the flow control controls the air flow in such a way that, in a pressure drop range of 50 Pa to 450 Pa between the supply air side and the exhaust air side of the filter body, the composition of the air flow in the analysis region changes by less than 25%, in particular less than 10%, preferably less than 4% compared to the composition in the filter region.

In particular, the solution according to the invention is suitable for pocket filters of primary ventilation systems and large-area filter modules of secondary ventilation systems. In both use variants, the use of the filters takes place in a pressure drop range of 50 to 450 Pascal. Precisely this large pressure drop range is the challenge according to the invention, because the following problems occur when such a filter system is intended to realize both filtering and also an analysis function. Due to the fact that the pressure drop in the analysis region is the result of different measures than that in the filter region, (if no corresponding compensation is provided) normally also a different characteristic curve of pressure drop to volume flow results.

However, many measuring methods are based on a constant throughflow. This can be achieved in that flow cross sections are deliberately kept small over a sufficient length. It is thereby achieved that the Reynolds number Reₖᵣᵢₜ over 2000 is already achieved with a small pressure drop.

$$R e = \frac{{v}_{m} \cdot d}{ν}$$

Higher pressure differences then lead to a changeover into turbulent flow and to an exponentially increasing rise in resistance in the supply, which has a stabilizing effect on the air throughput.

In the case of quantitative measuring methods, the above stabilization leads to an incorrect measurement, because then of the total volume flow of the air at a high pressure drop proportionally more flows through the filter region than through the analysis region. This can be counteracted by parallel measurement of the pressure drop and a corresponding correction of the measured values. Alternatively, the filter design can be constructed such that the filter of the filter region also exhibits a behavior similar to the volume flow limitation in the analysis region.

According to the invention, this can be achieved in the filter design, by controlling the air flow or by corresponding filter material design.

In a pure filter, flow differences do not play a major role over the service life of the filter. More strongly through-flowed regions first fill with filtered-off particles, which in turn increases the flow resistance in the region, so that then a previously less through-flowed region is preferably flowed through and the filter also fills there. According to the invention, the filter in the filter region is configured with a larger filter capacity than would actually be necessary for the service life. As a result, less enlargement of the pressure drop takes place during the service life of the filter (i.e. the filter is then replaced for reasons of the [service life] time overrun and not because of a high delta P because of an excessively high occupancy).

The solution according to the invention structurally ensures that the analysis region contains a composition representative of the air flow content even in the case of changing pressure conditions. In this case, the analysis region is formed in a region of the through-flowed cross section, which has a uniform laminar flow. In particular in edge zones (mainly above a certain roughness of the air flow guidance) or in the surroundings of edges and air flow deflections, a transition from laminar to turbulent takes place rapidly, which leads to inhomogenization of the solid portion in the air due to the acting centrifugal forces (as already mentioned).

It is pointed out that the embodiments described here represent only a limited selection of possible embodiment variants of the invention. Thus, it is possible to combine the features of individual embodiments with one another in a suitable manner, so that a plurality of different embodiments are to be regarded as obviously disclosed for the person skilled in the art with the embodiment variants explicit here. In particular, some embodiments of the invention are described with device claims and other embodiments of the invention with method claims. However, the person skilled in the art will immediately understand when reading this application that, unless explicitly stated otherwise, in addition to a combination of features which belong to a type of subject matter of the invention, an arbitrary combination of features which belong to different types of subject matter of the invention is also possible.

### BRIEF DESCRIPTION OF THE DRAWINGS

In the following, exemplary embodiments are described in more detail with reference to the attached drawings for further explanation and for a better understanding of the present invention. In the drawings:

FIG. 1 shows a filter system with a filter module according to an exemplary embodiment.

FIG. 2 shows a schematic representation of a filter material for the filter body according to an exemplary embodiment.

FIG. 3 shows a schematic representation of wave shapes of the filter material according to an exemplary embodiment.

FIG. 4 shows a schematic representation of a filter module with a plurality of analysis regions according to an exemplary embodiment.

FIG. 5 shows a schematic representation with selectively closable sample chambers according to an exemplary embodiment.

FIG. 6 shows a schematic representation of a filter system with a filter module and a plurality of filter bodies according to an exemplary embodiment.

FIG. 7 shows a schematic representation of a filter body with an air guiding device according to an exemplary embodiment.

### DETAILED DESCRIPTION OF EXEMPLARY EMBODIMENTS

Identical or similar components in different figures are provided with identical reference numerals. The representations in the figures are schematic.

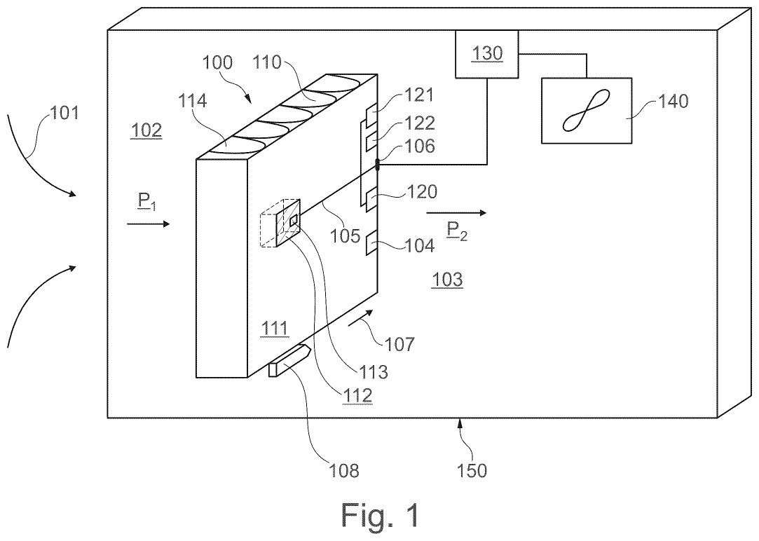

FIG. 1 shows a filter system 150 with a filter module 100 according to an exemplary embodiment. The filter system 150 comprises a control unit 130 and at least one filter module 100, wherein the at least one filter module 100 is configured to exchange analysis data, which are necessary for supporting the analysis of the air accompanying substances and/or the air quality.

The filter module 100 is provided for filtering air 101 of at least a part of a building or of air 101 of an exhaust air purification unit of a production process, wherein the filter module 100 can be replaceably arranged in a filter system 150 and the filter module 100 comprises a filter body 110 which is configured to filter air 101 when it flows through it. The filter body 110 comprises a filter region 111, which filters the air 101 which is flowing through from air accompanying substances, and an analysis region 112, which is configured to support the analysis of the air accompanying substances and/or the air quality, wherein the filter body 110 is configured in such a way that, at a speed of the volume flow of 0.1 m/s to 5.0 m/s through the filter body 110, the pressure drop of the air which flows through the filter body 110 is less than 450 Pascal. The filter region 111 is configured in such a way that, at a pressure drop range of 10 Pa to 450 Pa across the filter module 100, the composition of the air flow in the analysis region 112 changes by less than 40% compared to the composition in the filter region 111, and wherein the analysis region 112 is configured relative to the filter region 111 in such a way that the air 101 in the analysis region 112 comes into contact with the same air accompanying substances as in the filter region 111 by more than 90%.

The filter system 150 comprises a housing, in which a filter module 100 is arranged. A filter module 100 according to the invention is arranged exchangeably in the filter system 150. For example, corresponding guide rails can be provided, along which the filter module can be pushed into the insertion direction 107 as far as the operating position within the filter system 150.

The filter system 150 comprises a flow control 140, for example comprising a fan or other flow generators. A flow velocity of the air 101 through the filter body and an air pressure of the air 101 at the supply air side 102 of the filter body 110 are adjustable by means of the flow control 140. The flow control 140 is configured to adjust a pressure drop difference from a pressure drop between the pressure p1 of the supply air side 102 and the pressure p2 of the exhaust air side 103 in the filter region 111 and the analysis region 112 in each case individually, in particular by means of mechanical and/or mechatronic flow control systems, such that a constant volume flow through the filter region 111 and through the analysis region 112 is adjustable, in particular based on a subsequent adaptation based on measurement data.

The filter module 100 comprises a flat filter material, which is fixed in a circumferential support frame. The filter module 100 can be configured as a pocket filter, wherein a plurality of pockets 114 of filter material are fastened in the support frame and the air flow is introduced into the pockets 114 in order to filter the inflowing air 101.

The filter module 100 comprises in particular the filter region 111 which assumes the function of filtering the air 101. Furthermore, the filter module 100 according to the invention comprises the analysis region 112, which is configured to support an analysis of the air 102.

The analysis region 112 is at a sufficient distance from the support frame of the filter module 100 or from the edge of a flow channel, in which the filter module 100 is arranged in the filter system 150, in order thus to avoid edge flow properties, which bring about a different composition of the air particles of the air or a different pressure drop range of the air 101, relative to a, for example, central filter region.

The analysis region comprises a sensor element 113 for measuring at least one parameter of the air accompanying substances and/or the air quality of the air 101. The direct measurement of foreign substances or groups of foreign substances in the air flow can be provided by means of a sensor element 113 integrated in the analysis region 112. The sensor element 113 comprises, for example, a MEMS sensor. Furthermore, the sensor element 113 can be configured in particular such that the sensor element 113 can be used for a Fourier transform infrared spectrometer analysis FTIR and/or a near infrared spectroscopy analysis. The sensor element 113 can form, for example, a resistance sensor for measuring the air accompanying substances and/or the air quality. In this case, for example, a trigger substance can additionally be used in order to measure the presence of certain foreign substances in the air 101.

The filter module 100 comprises a communication unit 122 for communicating data relating to the air accompanying substances and/or the air quality, for example, to a control unit 130 of the filter system 150, in particular for controlling the filter module 100. The communication unit 122 is configured to transmit information about the air accompanying substances and/or the air quality to the control unit 130 or also to transmit control signals to the control unit 130, which can be created based on measured parameters, in order to generate, for example, control signals relating to indication signals (alarm signals) or air flow control signals.

The filter module 100 furthermore comprises (in a realization with wired communication) a coupling element 106, which is mechanically and/or electrically coupled to the analysis region 112 and can be coupled to a connection of a filter system 150. The coupling element 106 is configured in particular such that a releasable coupling between the analysis region 112 and the connection of the filter system 150 can be provided. Furthermore, the coupling element 106 is configured in particular such that, when the filter module 100 is introduced into an operating position in the filter system 150, a coupling between the connection of the filter system 150 and the analysis region 112 can be generated automatically. The coupling element 106 is provided on an exhaust air side 103 of the filter body 110. The coupling element 106 is provided in particular on the filter module 100, for example on the support frame of the filter module 100, such that, in an operating position of the filter module 100 in the filter system 150, a coupling to a correspondingly corresponding coupling element of the filter system 150 is enabled.

The filter module 100 furthermore comprises a weighing unit 108, which is configured to weigh the filter occupancy, in particular such that a measured value falsification by the pressure of the air 101 flowing through the system can be compensated. The weighing unit 108 comprises a ground contact in the installed state of the filter module 100 in the housing of the filter system 150 and thus introduce the weight force of the filter module 100 into the ground. As a result, a weight measurement of the filter module 100 can be carried out.

The filter module 100 comprises an optional receiving device 120, which is configured to receive a unique ID, wherein the unique ID comprises information regarding the location of use of the filter module 100. The receiving device 120 can be configured to read the unique ID from a QR code, a barcode, an OCR font or an RFID tag. Furthermore, the receiving device 120 can be configured to receive the unique ID via NFC, Bluetooth, WLAN, proprietary protocols or protocols of building control systems, in particular LON or EIB. The operation and/or the configuration of the filter module 100 is adjustable based on the unique ID. For example, the unique ID comprises information regarding the installation location of the filter module 100 in the filter system 150. This ID enables the operating parameters required for the specific operation to be preselected or stored data of a system configuration to be retrieved from a preconfigured operating mode of the filter system 150 or of the filter module 100.

The filter module 100 furthermore comprises an optional transmitting device 121 for transmitting filter body-related data, wherein the transmitting device 121 is configured to transmit the data by means of RFID, NFC, Bluetooth, WLAN or protocols of building control technology. A warning signal can be generated on the basis of these data by means of the control unit 130 and/or a measure can be taken which in particular relates to a throughput through the filter module 100.

The transmitting device 121 can for example be an antenna or a conductor-based system which signalizes the readiness of the ventilation system or filter system 150 to receive data from the filter module 100. Such data may relate not only to parameters relating to the air accompanying substances of the air 101, but also contain information and details of the filter module 100. Thus, for example, depending on the performance of a filter module 100 used, the air volume can be adapted by the filter module 100 or the filter system 150. Furthermore, when a run time or occupation density of the filter module 100 is exceeded, a signal can be emitted which can either be interpreted as a maintenance signal or can also be used as a control signal in order to reduce the air throughput quantity.

The analysis region 112 is arranged in particular more than 0.5 cm from the edge or support frame of the filter body 110, which acts as an outer air flow limitation, so that no edge effects with air flow turbulences occur in the analysis region 112.

The control unit 130 can comprise a visualization unit, which is configured to visualize the air quality and the analysis of the air particles or air accompanying substances, in particular in a location-dependent manner at the location of the respective filter system 150. Furthermore, the control unit 130 is configured in particular such that it generates an action recommendation based on the air quality and the analysis of the air accompanying substances.

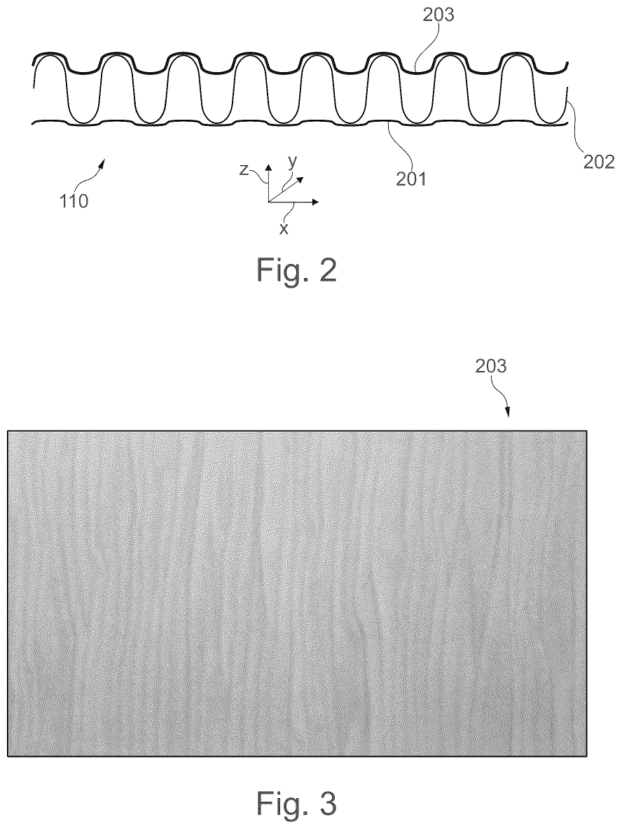

FIG. 2 shows a schematic representation of a filter material for the filter body 110 according to an exemplary embodiment. The filter body 110, in particular in the filter region 111, comprises a plurality of filter layers, which are arranged one behind the other in the flow direction of the air 101 through the filter, wherein in particular the first filter layer facing the supply air side 102 filters more coarsely than at least one of the second filter layers following the following first filter layer in the flow direction. Thus, initially coarser particles can be filtered, while smaller particles flow through the first layers and are only filtered out later in the case of the fine layers.

The filter body 110 or a layer comprises, in particular in the filter region 110, a fleece as filter material, wherein the fleece comprises in particular an entire layer or a plurality of layers.

The filter body 110 comprises at least two fleece layers 201, 203 and a filter membrane 202 arranged between the fleece layers, which are arranged in a layered manner one above the other in a third direction z in a layer composite, wherein in particular the middle filter membrane 202 of the layer composite comprises a larger surface area than the two outer fleece layers 201, 203.

The middle filter membrane 202 comprises corrugation sections, which are arranged one behind the other along a first direction x.

FIG. 3 shows a schematic representation of wave shapes of the filter material according to an exemplary embodiment.

The corrugation sections run irregularly and asymmetrically to each other, in particular within the plane. The filter body 110 is arranged such that air can flow over the filter body 110 along the first direction x or along the second direction y. For example, the x direction is the air inflow direction of the air 101 and the corrugation sections run transversely to the first direction x along the second direction y. The asymmetry of the corrugation arrangement and shape can be used for vibration damping.

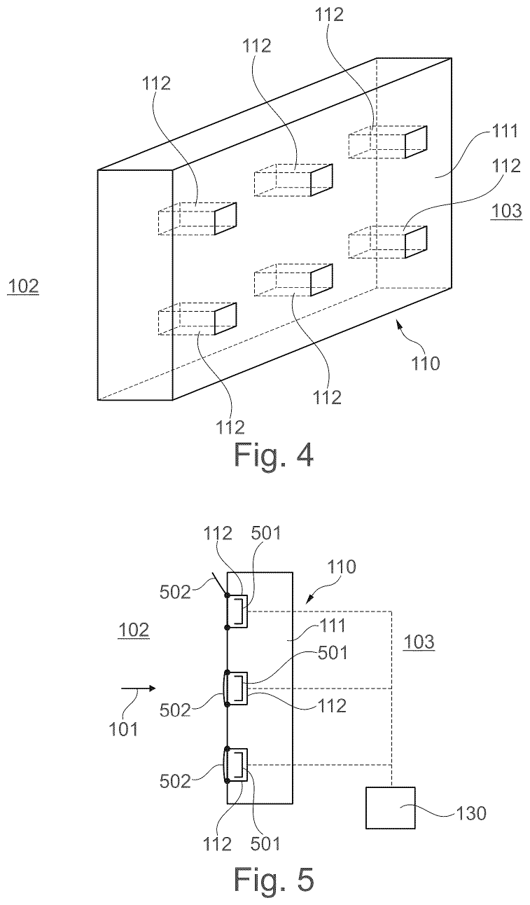

FIG. 4 shows a schematic representation of a filter module 100 with a plurality of analysis regions 112 according to an exemplary embodiment.

The analysis region 113 can be flowed through continuously or discontinuously. Therefore, for example, in the case of a discontinuous inflow of the analysis region 112, the latter can be selectively covered and the air flow can be flowed against it only at one measurement time. The analysis regions 112 have a collection volume for air accompanying substances. The analysis regions 112 can for example respectively form a pocket or bag, in which the collection volume is formed. Accordingly, air particles or other air accompanying substances can collect therein, which can be analyzed later, for example when the filter module 100 is removed. Furthermore, according to an exemplary embodiment, a sensor element 113 (see FIG. 1) can be installed in the collection volume in order to analyze the collected air accompanying substances.

The analysis regions 112 can respectively comprise an adhering region for adhering and accumulating air accompanying substances. The adhesion can for example be formed by a defined formation of the pore size of a filter material in the analysis region 112, or by certain adhesive-like substances, to which in particular the air particles adhere in the air. One of the analysis regions 112 can comprise a reactive region for reacting and converting air accompanying substances and/or air components.

FIG. 5 shows a schematic representation with selectively closable sample chambers 501, through which the air for filtering air accompanying substances or air particles can flow selectively, in order to enable in particular a time-delayed sample collection. The sample chambers 501 can be arranged distributed or together in a certain region of the filter body 110 or within the filter region 111. The sample chambers 501 are arranged in such a way that the speed according to the invention of the volume flow of 0.1 m/s to 5.0 m/s and the pressure drop of the air 101 which flows through the filter body is less than 450 Pascal. Furthermore, the sample chambers 501 are configured and arranged in such a way that, at a pressure drop range of 10 Pa to 450 Pa across the filter module, the composition of the air flow in the sample chambers 501 of the analysis region 112 changes by less than 40% compared to the composition in the filter region 111, and the sample chambers 501 in the analysis region 112 are configured relative to the filter region 111 in such a way that the air in the sample chambers comes into contact with the same air accompanying substances or air particles as in the filter region 111 by more than 90%.

The sampling devices 501 which are arranged in the analysis region 112 can be arranged exchangeably. A collection volume for the air accompanying substances is formed in the sampling devices 501. The sampling device 501 is in particular sealable in order to seal the collection volume partially, completely and/or selectively. The sampling devices 50 can for example be sealed after a certain period of time, in which air accompanying substances are collected in the collection volume. Subsequently, the sampling device 501 can be removed and the collected air particles or liquid can be analyzed in an external laboratory.

The sampling devices 501 comprise for example a closure mechanism, such as for example a closure element 502 (for example a closable flap). The corresponding opening and closing of the sampling device 501 can for example be controlled by the control unit 130 of the filter system 150.

By means of the closure elements 502, the sample chambers 501 can be selectively flowed through in that, for example, one or selected sample chambers 501 are accessible for the air flow as a function of time. Alternatively, an air guiding system, consisting of air guides and control valves, can be used in order to guide an air flow to a certain sample chamber 501 in a targeted manner at a certain point in time.

By means of the sample chambers 501, a plurality of through-flowable analysis regions 112 are thus formed, which can be selectively controlled in such a way that the through-flowable analysis regions 112 can be flowed through independently of each other at a predetermined point in time and for a predetermined through-flow duration in such a way that a binary tree is formed on the basis of the measurement at the predetermined points in time of the through-flow of the individual through-flowable analysis regions 112. The data of the measured parameters of the air accompanying substances in the through-flowable analysis regions 112 are indicative of a state of the air flow over a time range and of a change of state over the through-flow duration of the through-flowed analysis regions 112. Due to the additional temporal dimension, the various states and changes of state over certain time ranges of the air accompanying substances can thus be mapped in a data matrix or in a binary tree.

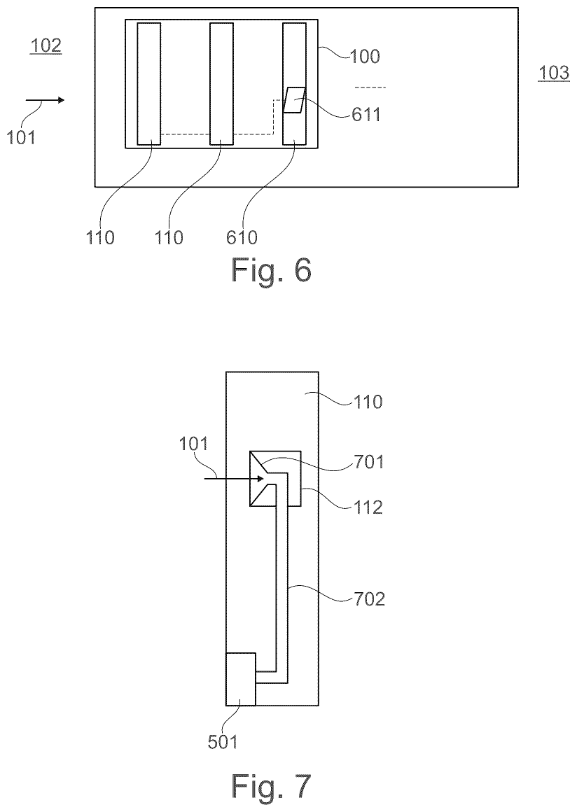

FIG. 6 shows a schematic representation of a filter system 150 with a filter module 100 and a plurality of filter bodies 110, 610 according to an exemplary embodiment. The filter bodies 110, 610 consist for example in each case of pocket filters or a hose filter, wherein at least one filter body 610 consists for example exclusively of an analysis region 112, which is configured for the analysis of the air accompanying substances and the air quality. For example, at least one filter body 610 consists exclusively of an analysis region 112 comprising a power supply unit 611, which is configured in particular such that a power supply can be provided for a predetermined service life of the filter module 100. In the exemplary embodiment, the filter module 100 comprises corresponding filter bodies 110, 610 arranged serially behind each other.

The energy or power generating unit 611 is configured for example to obtain energy by means of the air flow 101 through the filter module 100 and/or by electromagnetic waves, which energy is used in particular for operating the analysis region 112.

FIG. 7 shows a schematic representation of a filter body 110 with an air guiding device 702 according to an exemplary embodiment. The air guiding unit 702 comprises an air path to the supply air side 102 and/or to the exhaust air side 103 of the filter body 110, wherein the air guiding unit 702 is configured in particular exchangeably in the filter body 110. The air path thus leads through the analysis region 112. The air paths thus lead the air 101 for example to a measuring device of the filter system 150, wherein the filter module 100 can be replaced independently of the measuring device. In particular, an intermediate material with filter properties or with active reagents can be provided in the air path.

The analysis region 112 further comprises an air guiding region 701 for extracting air flow from the filter body 110. For example, the air guiding region 701 can be configured conically and funnel-shaped, in order to take up an air portion from the flowing air 101 and to be transported further to a desired location in a further line system outside the filter module 100. For example, the air portion can be collected in a collection container of the filter system 150 and can be provided for the further analysis. The air guiding unit 701 can also lead the air to a removable sample chamber 501, in which, for example, the air accompanying substances can be collected.

In addition, it should be noted that “comprising” does not exclude any other elements or steps and “a” or “an” does not exclude a plurality. Furthermore, it should be noted that features or steps which have been described with reference to one of the above exemplary embodiments can also be used in combination with other features or steps of other exemplary embodiments described above. Reference signs in the claims are not to be regarded as a restriction.

List of reference signs:

100 Filter module
101 Air
102 Supply air side
103 Exhaust air side
104 Energy generating unit
105 Signal connection
106 Coupling element
107 Insertion direction
108 Weighing unit
110 Filter body
111 Filter region
112 Analysis region
113 Sensor element
114 Filter pocket
120 Receiving device
121 Transmitting device
122 Communication unit
130 Control unit
140 Flow control
150 Filter system
201 Outer fleece layer
202 Filter membrane
203 Outer fleece layer
501 Sampling device/sample chamber
502 Closure element
610 Further filter body
611 Power supply unit
701 Air guiding region
702 Air guiding unit
x First direction
y Second direction
z Third direction
p1 Pressure supply air side
p2 Pressure exhaust air side

1. A filter module for filtering air of at least a part of a building or of air of an exhaust air purification unit of a production process,
wherein the filter module is replaceably arrangeable in a filter system,
wherein the filter module comprises a filter body, which is configured to filter air when it flows through, wherein the filter body comprises:
a filter region, which filters the air which is flowing through from air accompanying substances; and
an analysis region, which is configured to support the analysis of at least one of the air accompanying substances and the air quality,
wherein the filter body is configured in such a way that, at a speed of the volume flow of 0.1 m/s to 5.0 m/s through the filter body, the pressure drop of the air which flows through the filter body is less than 450 Pascal,
wherein the filter region is configured in such a way that, at a pressure drop range of 10 Pa to 450 Pa across the filter module, the composition of the air flow in the analysis region changes by less than 40% compared to the composition in the filter region, and
wherein the analysis region is configured relative to the filter region in such a way that the air in the analysis region comes into contact with the same air accompanying substances as in the filter region by more than 90%.

2. The filter module according to claim 1,
wherein the analysis region has a collection volume for air accompanying substances.

3. The filter module according to claim 2, further comprising
a sampling device which is arranged in the analysis region and in which the collection volume is formed.

4. The filter module according to claim 1,
wherein the analysis region has an adhering region for at least one of adhering and accumulating air accompanying substances.

5. The filter module according to claim 1,
wherein the analysis region has a reactive region for reacting and converting at least one of air accompanying substances and air components.

6. The filter module according to claim 1,
wherein the analysis region has an air guiding region for extracting air flow from the filter body.

7. The filter module according to claim 1,
wherein the analysis region has a sensor element for measuring at least one parameter of at least one of the air accompanying substances and the air quality.

8. The filter module according to claim 5,
wherein the sensor element comprises a MEMS sensor.

9. The filter module according to claim 7,
at least one of wherein the sensor element comprises a resistance sensor for measuring at least one of the air accompanying substances and the air quality, and
wherein the sensor element comprises a microphone which is configured to detect the noise level in a room such that the number and intensity of speech-active persons in the room can be determined by means of measuring and evaluating the noise level in the room.

10. The filter module according to claim 1, comprising at least one of the following features:
i) further comprising
a communication unit for communicating data relating to at least one of the air accompanying substances and the air quality to a control unit of the filter system;
ii) wherein the filter body comprises a plurality of analysis regions;
iii) wherein the analysis region is configured to indicate the presence of substance classes, at least one of wherein the analysis region is configured to filter and collect air accompanying substances from the air, and
wherein the analysis region is configured to preserve samples of the air accompanying substances;
iv) further comprising
an energy generating unit, which is configured to obtain energy by means of at least one of the air flow through the filter module and by electromagnetic waves;
v) wherein the analysis region comprises a plurality of sample chambers, through which the air for filtering air accompanying substances can flow selectively;
vi) wherein the filter body comprises a fleece as filter material,
wherein the filter body is arranged in the filter module;
vii) wherein the filter region and the analysis region are arrangeable in parallel in the air flow in such a way that at least one of the filter module is configurable as part of a secondary filter system and the filter module is configurable as part of a pocket filter;
viii) wherein the inflow of the air to the analysis region is controllable in such a way that at least one of a flow and pressure difference of the air in the filter region and in the analysis region is adjustable.

11-17. (canceled)

18. The filter module according to claim 1,
wherein the analysis region can be flowed through continuously or discontinuously.

19. The filter module according to claim 18,
wherein at least one of in a discontinuous operation the analysis region can be activated relative to the filter region in a time duty cycle ratio of less than 10:1, and
the active measuring time of a flow-through cycle of the filter body is shorter than 10 ms.

20. The filter module according to claim 1, comprising at least one of the following features:
i) further comprising
a coupling element, which is at least one of mechanically and electrically coupled to the analysis region and can be coupled to a connection of a filter system,
ii) further comprising
at least one further filter body,
wherein at least one filter body consists exclusively of an analysis region, which is configured for the analysis of the air accompanying substances and the air quality.

21. (canceled)

22. The filter module according to claim 1,
wherein the filter body comprises at least two fleece layers and a filter membrane arranged between the fleece layers, which are arranged in a layered manner one above the other in a layer composite.

23. The filter module according to claim 22,
wherein a first direction and a second direction span a plane,
wherein the middle filter membrane is corrugated with corrugation sections such that the corrugation sections are arranged one behind the other along a first direction,
wherein the corrugation sections run irregularly and asymmetrically to each other and
wherein the filter body is arranged such that air can flow over the filter body along the first direction or along the second direction;
at least one of wherein the filter body has a thickness of 2 mm to 10 mm in the filter region, and
wherein the number of corrugation sections is between 0.5 and 3 corrugations per cm.

24. (canceled)

25. The filter module according to claim 1, comprising at least one of the following features:
i) at least one of wherein the filter region is configured from a hydrophobic filter material, and
wherein the filter region is made of natural fibers, and
wherein the filter region contains a polyolefin, and
wherein the filter region contains cellulose, cotton and hemp;
ii) wherein the analysis region comprises an air guiding unit,
wherein the air guiding unit is formed in the filter body;
iii) further comprising
a weighing unit, which is configured to weigh the filter occupancy;
iv) further comprising
a receiving device, which is configured to receive a unique ID,
wherein the unique ID comprises information regarding the location of use of the filter module,
at least one of wherein the receiving device is configured to read the unique ID from a QR code, a barcode, an OCR font or an RFID tag, and
wherein the receiving device is configured to receive the unique ID via NFC, Bluetooth, WLAN, proprietary protocols or protocols of building control systems,
wherein at least one of the operation and the configuration of the filter module is adjustable based on the unique ID;
v) further comprising
a transmitting device for transmitting filter body-related data,
wherein the transmitting device is configured to transmit the data by means of RFID, NFC, Bluetooth, WLAN or protocols of building control technology,
wherein at least one of a warning signal can be generated on the basis of these data by means of a control unit and a measure can be taken;
vi) wherein the analysis region comprises a plurality of through-flowable regions, which can be selectively controlled in such a way that the through-flowable regions can be flowed through independently of one another at a predetermined point in time and for a predetermined through-flow duration in such a way that a binary tree is formed on the basis of the measurement at the predetermined points in time of the through-flow of the individual through-flowable regions;
vii) wherein the analysis region is arranged more than 0.5 cm from the edge of the filter body, which acts as an outer air flow limitation;
viii) wherein the filter body comprises a plurality of filter layers, which are arranged one behind the other in the flow direction of the air through the filter;
ix) wherein the filter body comprises a pocket filter, a cartridge filter, a hose filter, a candle filter, a compact filter or a HEPA filter.

26-33. (canceled)

34. A filter system, comprising
a control unit; and
at least one filter module according to claim 1,
wherein the at least one filter module is coupled to the control unit for exchanging analysis data, which are necessary for supporting the analysis of at least one of the air accompanying substances and the air quality.

35. The filter system according to claim 34,
wherein the control unit comprises a visualization unit, which is configured to visualize the air quality and the analysis of the air accompanying substances.

36. The filter system according to claim 34, comprising at least one of the following features:
i) further comprising
a flow control,
wherein a flow velocity of the air through the filter body and an air pressure of the air at the supply air side of the filter body are adjustable by means of the flow control,
wherein the flow control is configured to adjust a pressure drop difference from a pressure drop between the supply air side and the exhaust air side in the filter region and the analysis region in each case individually, such that a constant volume flow through the filter region and through the analysis region is adjustable;
ii) wherein the flow control is configured to adjust at least one of the speed of the volume flow in the range 0.1 to 5.0 m/s, and the pressure drop across the filter body in at least one operating mode below 250 Pa;
iii) wherein the flow control controls the air flow in such a way that, in a pressure drop range of 50 Pa to 450 Pa between the supply air side and the exhaust air side of the filter body, the composition of the air flow in the analysis region changes by less than 25% compared to the composition in the filter region.

37-38. (canceled)

39. A method for filtering air of at least a part of a building or of air of an exhaust air purification unit of a production process with an exchangeable filter module according to claim 1.
